(19) United States
(12) Patent Application Publication
(10) Pub. No.: US 2018/0315117 A1
(43) Pub. Date: Nov. 1, 2018

(54) On-Line Retail

(71) Applicant: David Lynton Jephcott, Stoke On Trent (GB)

(72) Inventor: David Lynton Jephcott, Stoke On Trent (GB)

(21) Appl. No.: 15/962,270

(22) Filed: Apr. 25, 2018

Related U.S. Application Data
(60) Provisional application No. 62/490,111, filed on Apr. 26, 2017.

(51) Int. Cl. G06Q 30/06; G06T 19/00; G06T 13/40

(52) U.S. Cl. CPC G06Q 30/0643; G06Q 30/0633; G06F 3/04815; G06T 19/006; G06T 13/40; G06Q 30/0623

(57) ABSTRACT

A user friendly interactive electronic on-line retail communications system and process for use in on-line retail shopping, can provide a computer system with at least one display and inputting device operatively connected by hard wires or a wireless internet connection to a central processing unit (CPU) for interaction between a virtual store and a customer. The attractive on-line retail communications process provides for enjoyable on-line retail shopping by generating an interactive avatar to assist the customer in selecting virtual products. Advantageously, the avatar is an advice avatar or a female or male interactive shopping avatar that provides a virtual salesperson. The avatar can provide visual and/or audible information about the virtual products. Desirably, a customer-like avatar with an appearance similar to the customer can be also be provided for wearing or using the virtual products.

### BACKGROUND OF THE INVENTION

This invention relates to retail, and more particularly, to improved on-line retail.

Retail shopping over past decades has been conducted in streets and department stores in every town and city around the world and the public would enter a shop and look around. It would not be long before an assistant would move in to try to help the customer and to hopefully accelerate a decision to purchase and item or more than one.

This salesmanship become part of society and we had the choice to accept this intervention or to say “No Thanks, we are just looking around” After a while the customer may approach an assistant again and ask for information or advice.

The internet highway introduces the equivalent of an Industrial Scale Revolution as the world population in the 20^{th} and 21^{st} century have less time to shop physically and are turning to on-line retailing as a solution. This paradigm shift will never reverse and so virtual worlds and experiences will gradually sound the death knell for bricks and mortar establishments.

Typically on the internet, for retail, there is no “salesmanship” and the customer is left to wander endless pages searching for what they seek, be it clothing, shoes, furniture, do it yourself (DIY) materials, white goods or information technology (IT) products, music, and books.

Most if not all of the existing internet sites are nothing more than catalogues with many pages and Items portrayed as photo images and a price tag and brief description for us to read.

The decision is left totally in the customer's hands as to whether they buy or not

Problems for the retailer in using high street shops is the high cost of rental and rates in addition to heating lighting, security and inventory purchase and management in addition to theft.

The world is moving very quickly away from shopping in the traditional way of visiting shops and stores towards the convenience of on-line retail.

It is, therefore, desirable to provide an improved on-line retail, which overcomes most, if not all of the preceding problems and disadvantages.

### BRIEF SUMMARY OF THE INVENTION

An improved interactive electronic on-line retail communications system and process for use in on-line retail shopping is provided which is effective, efficient and economical. Advantageously, the novel interactive electronic on-line retail communications system and process for use in on-line retail shopping is easy to use, fun, and convenient. Desirably, the user friendly interactive electronic on-line retail communications system and process for use in on-line retail shopping is reliable, attractive and helpful.

The user friendly interactive electronic on-line retail communications system and process for use in on-line retail shopping, can provide a computer system with at least one display and inputting device operatively connected by hard wires (wiring) or a wireless internet connection to a central processing unit (CPU) for interaction between a virtual store and a customer comprising the user of the CPU.

The CPU can be: a computer, laptop computer, desktop computer, portable computer, microprocessor, tablet computer, wireless computer, wired computer, netbook, internet communications device, portable networking device, electronic communications device, network communications device, cloud network communications device, electronic subscriber device, mobile phone, flip phone, camera phone, clamshell device, radio telephone, cellular phone, smart phone, tablet phone, portable media player (PMP), personal digital assistant (PDA), wireless e-mail device, handheld electronic device, mobile electronic device, virtual reality device, virtual reality headset, or combinations of any of the preceding;

The display can be: a screen, touch screen, touchpad, monitor or combinations of any of the preceding;

The inputting device can be: a keypad, retractable keypad, screen pad, touch pad, keyboard, retractable keyboard, keys, buttons, electronic mouse, audible input, Bluetooth, verbal input device, microphone, transmitter, electronic mouse, optical scanner, card reader, optical scanner, streaming device, audio tape, video tape, computer disc (CD), digital video disc (DVD), universal serial bus (USB) device, flash drive, or combinations of any of the preceding

The user friendly interactive electronic on-line retail communications system and process for use in on-line retail shopping can include: generating virtual products on the display by the CPU; generating at least one interactive avatar on the display to assist the customer in selecting at least one of the virtual products; electronically transmitting information from the customer to the CPU by the inputting device; and generating at least one virtual facility with the virtual products on the display.

The virtual retail facility can be: a virtual shopping mall, virtual shop, virtual store, virtual high street, virtual room setting, virtual catwalk virtual restaurant, virtual outdoor setting, virtual furniture shop, virtual hardware store, virtual garment store, virtual clothing store, virtual shoe sore, virtual office, virtual e-commerce bank, virtual financial institution, virtual currency exchange; a virtual department store, or combinations of any of the preceding.

The virtual products can be: virtual goods, virtual white goods, virtual wares, virtual garments, virtual clothes, virtual tops, virtual blouses, virtual jackets, virtual coats, virtual pants, virtual jeans, virtual skirts, virtual scarfs, virtual sweaters, virtual, shoes, virtual handbags, virtual purses, virtual cosmetics, virtual services, virtual real estate, virtual house, virtual apartments, virtual flats, virtual currency, virtual crypto coins, virtual bit coins, virtual loans, virtual mortgages, virtual banking, virtual insurance, virtual games, virtual vehicles, virtual cars, virtual automobiles, virtual trucks, virtual sports utility vehicles, virtual tools, virtual fasteners, virtual garden equipment, virtual supplies, virtual art, virtual jewelry, virtual collectibles, virtual memorabilia, virtual sports memorabilia, virtual food, virtual travel, virtual vacations, virtual holidays, virtual cruises, virtual tickets, virtual cruise tickets, virtual travel tickets, virtual tour tickets, virtual bus tickets, virtual railroad tickets, virtual airplane tickets, virtual theater tickets, virtual event tickets, virtual concert tickets, virtual sports tickets, virtual movie tickets, virtual movies, virtual prerecorded television programs, virtual software, virtual supplies, virtual devices, virtual equipment, virtual garden equipment, virtual furniture, or combinations of any of the preceding.

The avatar on the display is preferably wearing, holding or pointing to or otherwise associated with at least one of the virtual products. Desirably, the avatar comprises a virtual salesperson. The virtual salesperson can be an interactive shopping avatar, an advice avatar, an actual salesperson in a gif format, or any combinations of the preceding. The interactive shopping avatar can be a female shopping avatar, male shopping avatar, or animated animal.

Advantageously, the interactive shopping avatar electronically provides information about the virtual products to the customer including electronically transmitting visual information on the display and/or audible information spoken through the speaker of the CPU to the customer.

In the interactive electronic on-line retail communications process for use on-line retail shopping, information can be electronically transmitted to the CPU by the customer with the inputting device by one or more of the following:
(1) visual information comprising a photograph of the customer optically scanned into the optical scanner of CPU by the customer. The avatar can also include another avatar which is visually similar to the customer based upon the photograph of the customer.
(2) visual information comprising a photograph of the customer by a camera of CPU The avatar can includes a further avatar which has a virtual face similar to the face of the customer based upon the photograph of the customer.
(3) measurements of the customer, such as height, weight, sleeve length, pants length skirt size, skirt length, waist size, bust size, with collar size, race, skin color, eye color, hair color, hair style, hair length, or combinations of any of the preceding. The measurements are inputted to the CPA by the customer through an inputting device. The avatar can includes yet another avatar which has an appearance or likeness similar to the customer based upon the information provided by the customer; and/or
(4) audible information including preferences and requests spoken into the microphone of the CPU by the customer.

In the interactive electronic on-line retail communications process for use on-line retail shopping, the avatar can comprise: a three dimensional (3D) avatar, animated avatar, avatar with lip synchronized speech, a virtual mannequin, a personal profile mannequin, an avatar selected from an electronic menu of different avatars, or combinations of any of the preceding.

A more detailed explanation of the invention is provided in the following detailed descriptions and appended claims taken in conjunction with the accompanying drawings.

### BRIEF DESCRIPTION OF THE DRAWINGS

FIG. 1 is a diagrammatic view of a virtual shopping mall in accordance with principles of the present invention.

FIG. 2 is a diagrammatic view of a virtual high street in accordance with principles of the present invention.

FIG. 3 is a diagrammatic view of a virtual individual shop front in accordance with principles of the present invention.

FIG. 4 is a diagrammatic view of a typical avatar in a room setting in accordance with principles of the present invention.

FIG. 5 is a diagrammatic view of an avatar in a catwalk setting in accordance with principles of the present invention.

FIG. 6 is a diagrammatic view of an avatar in another setting in accordance with principles of the present invention.

FIG. 7 is a diagrammatic view of an avatar in a restaurant setting in accordance with principles of the present invention.

FIG. 8 is a diagrammatic view of an avatar in a customized catwalk setting in accordance with principles of the present invention.

FIG. 9 is a diagrammatic view of a virtual franchise area providing a coffee shop in accordance with principles of the present invention.

FIG. 10 is a diagrammatic view of a virtual customized shop interior showing client's products in accordance with principles of the present invention.

FIG. 11 is a diagrammatic view of a virtual customized shop interior showing client's garments in accordance with principles of the present invention.

FIG. 12 is diagrammatic view of a virtual do it yours (DIY) shop or department in a virtual mall in accordance with principles of the present invention.

FIG. 13 is diagrammatic view of a virtual garment display in accordance with principles of the present invention.

FIG. 14 is diagrammatic view of a virtual furniture shop or department in accordance with principles of the present invention.

FIG. 15 is diagrammatic view of a virtual travel shop or department in accordance with principles of the present invention.

FIG. 16 is diagrammatic view of a virtual office of solicitors, attorneys, or insurance agents in accordance with principles of the present invention.

FIG. 17 is diagrammatic view of a virtual e-commerce bank with a staff of avatars in accordance with principles of the present invention.

FIG. 18 is diagrammatic view of a virtual store in accordance with principles of the present invention.

FIG. 19 is diagrammatic view of a female shopping avatar in accordance with principles of the present invention.

FIG. 20 is diagrammatic view of a female shopping avatar with a rack of virtual dresses in accordance with principles of the present invention.

FIG. 21 is diagrammatic view of a female shopping avatar with different virtual dresses in accordance with principles of the present invention.

FIG. 22 is diagrammatic view of a female shopping avatar illustrating different bust and upper body types and different length and hip measurements in accordance with principles of the present invention.

FIG. 23 is diagrammatic view of a female shopping avatar with different tops, skirts, jeans and shoes in accordance with principles of the present invention.

FIG. 24 is diagrammatic view of mix and match jeans and tops in accordance with principles of the present invention.

FIG. 25 is diagrammatic view of a female shopping avatar with different shoes in accordance with principles of the present invention.

FIG. 26 is diagrammatic view of another female shopping avatar in accordance with principles of the present invention.

FIG. 27 is diagrammatic view of a female shopping avatar with a virtual brand in accordance with principles of the present invention.

FIG. 28 is diagrammatic silhouette front and side views of a female avatar model in accordance with principles of the present invention.

FIG. 29 is a diagrammatic view of an interactive electronic on-line retail communications system and process for use in on-line retail in accordance with principles of the present invention.

### DETAILED DESCRIPTION OF THE INVENTION

The following is a detailed description and explanation of the preferred embodiments of the invention and best modes for practicing the invention.

The on-line retail concept providing an interactive electronic on-line retail communications system and process of this invention, sometime referred to as Yooreka, can provide virtual stores, offices, and malls, as well as virtual retail stores and virtual department stores, sometimes referred to as Yooreka Towers, to provide various products (goods) and services with the assistance of avatars. This concept has one other major unique selling point. We seek to bring salesmanship back into retail which was a huge factor in real-time high street shopping but which has been totally ignored in e-commerce and on-line shopping. This full concept brings back sales support and encouragement by trained and programmed avatars who can replace or assist the human sales people and who contribute significantly to a sale being made.

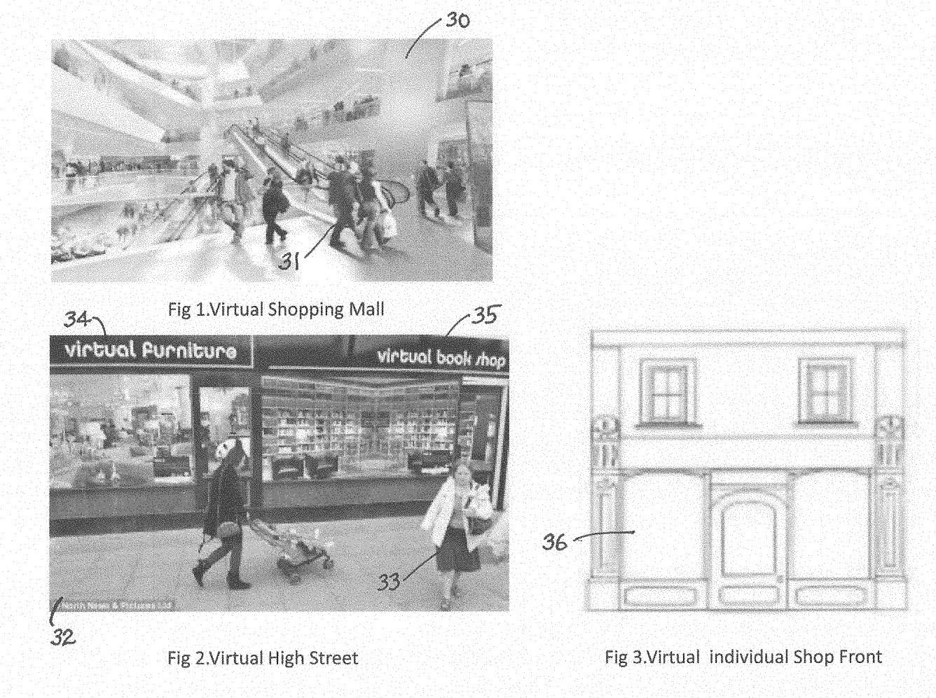

FIG. 1 is illustrates a virtual shopping mall 30 with virtual customers 31.

FIG. 2 illustrates a virtual high street 32 with other virtual customer 33 walking past a virtual furniture store 34 and a virtual book shop (store) 35.

FIG. 3 illustrates a virtual individual shop front 36.

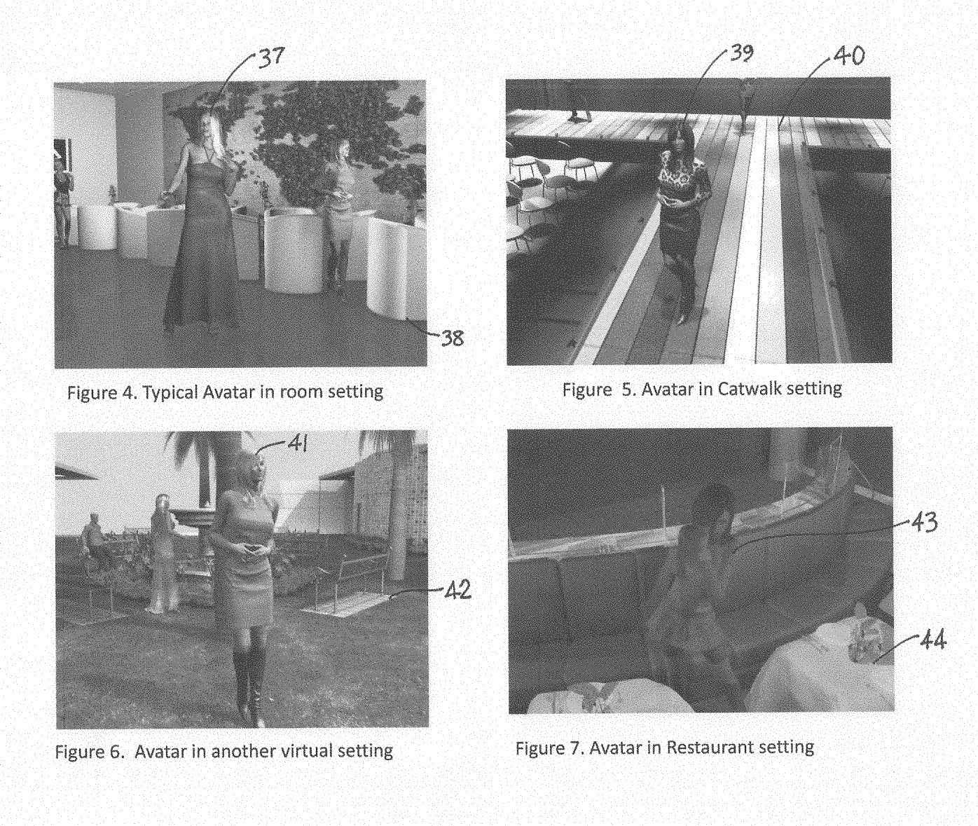

FIG. 4 illustrates a typical avatar 37 in a virtual room setting 38.

FIG. 5 illustrates another avatar 39 in a virtual catwalk setting 40.

FIG. 6 illustrates a further avatar 41 in a virtual outdoor setting 42.

FIG. 7 illustrates yet another avatar 43 in a virtual restaurant setting 44.

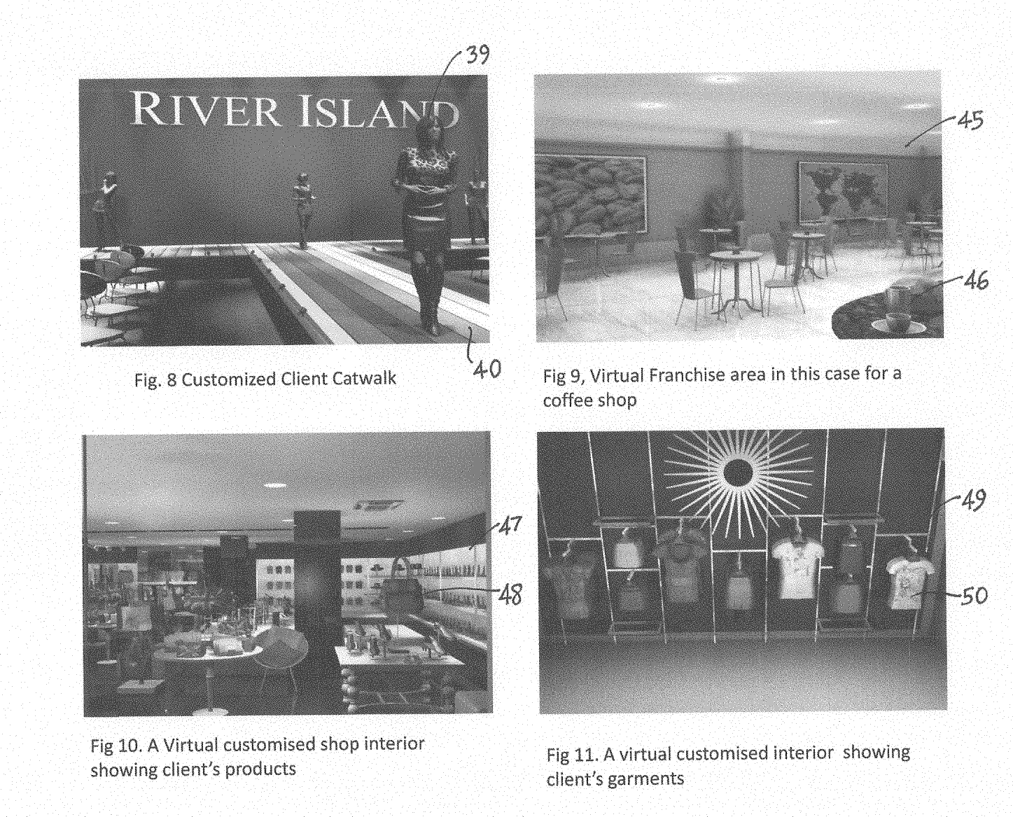

FIG. 8 illustrates the typical avatar 39 in a virtual customized catwalk setting 40.

FIG. 9 illustrates a virtual franchise area 45 providing a virtual coffee shop 46.

FIG. 10 illustrates a virtual customized shop interior 47 showing a virtual stores' products 48.

FIG. 11 illustrates another virtual customized shop interior 49 showing the virtual stores' garments (clothing) 50.

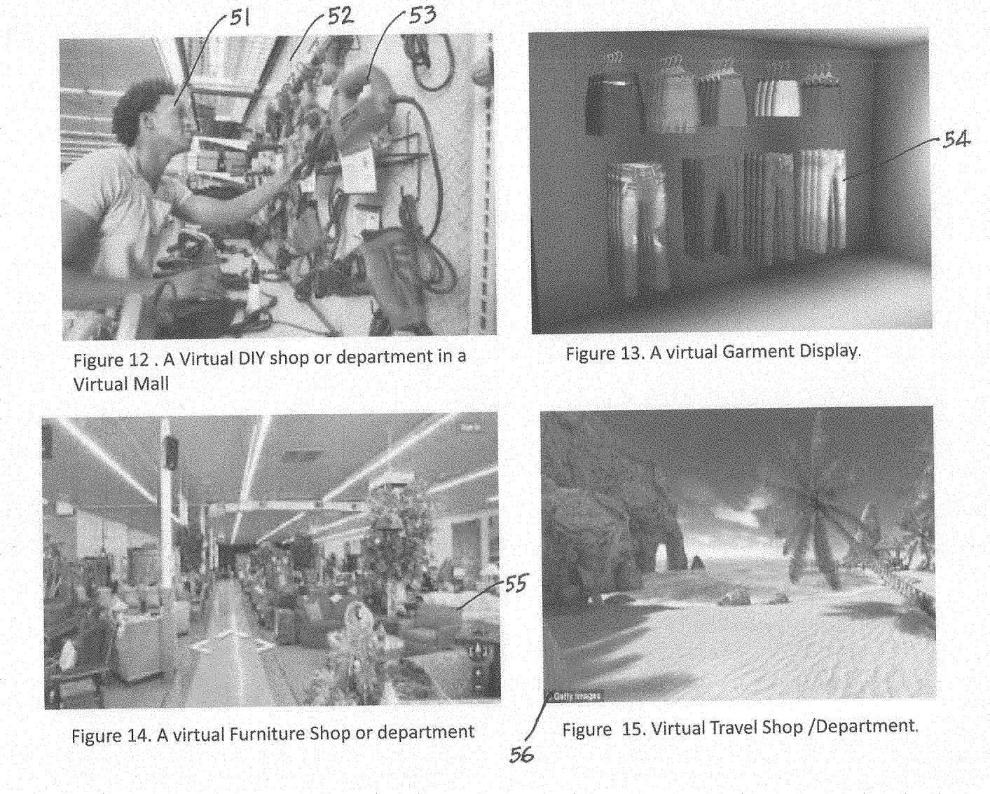

FIG. 12 illustrates another avatar 51 in a virtual do it yourself (DIY) shop 52 or department in a virtual mall 53.

FIG. 13 illustrates a display of virtual garments 54 comprising virtual clothing for men, women, boys and girls.

FIG. 14 illustrates another virtual furniture shop (store) 55 or department.

FIG. 15 illustrates a virtual travel shop (store) 56 or department.

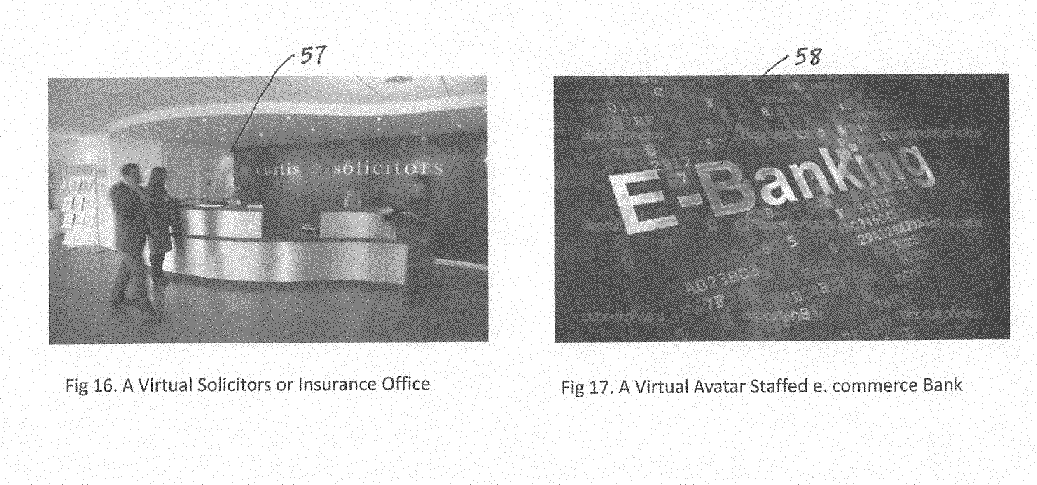

FIG. 16 illustrates a virtual office 57 of solicitors, attorneys, or insurance agents.

FIG. 17 illustrates a virtual e-commerce bank 58 providing a virtual financial institution or currency exchange for electronically transacting banking business or exchange of virtual currency including crypto coins, bit coins, etc.

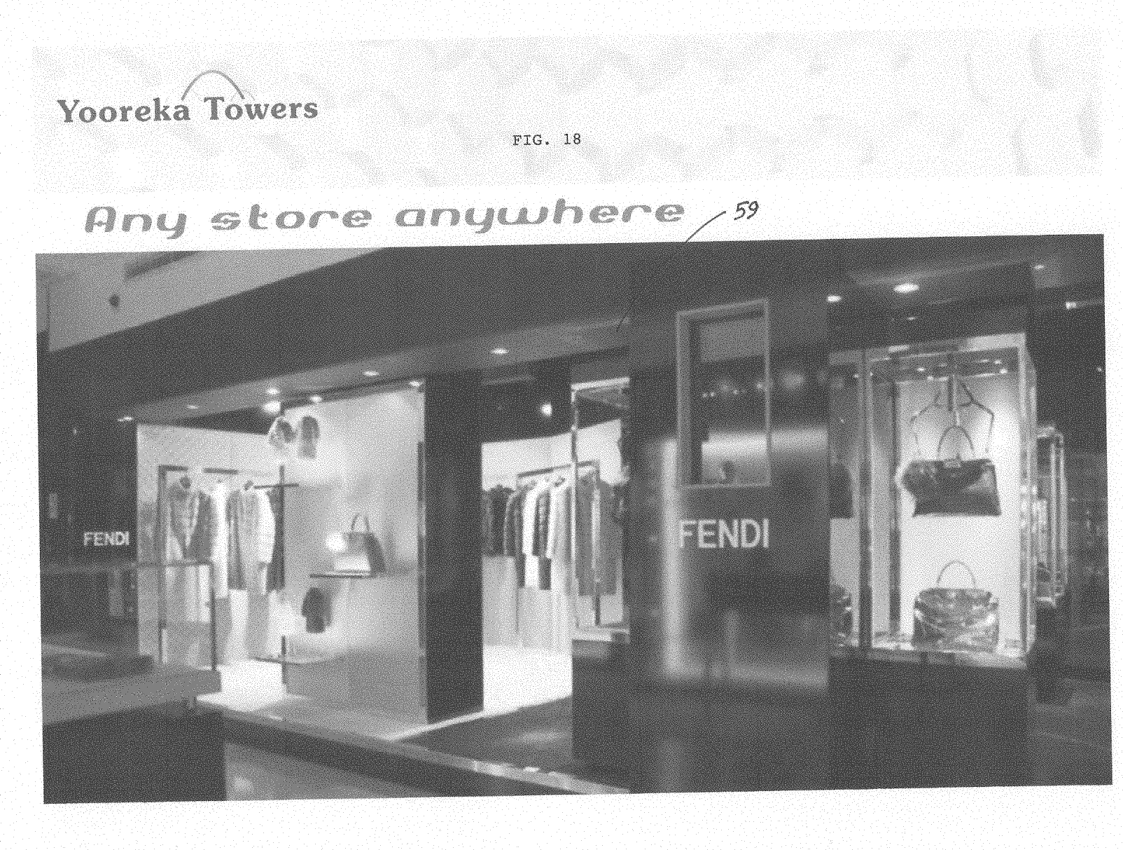

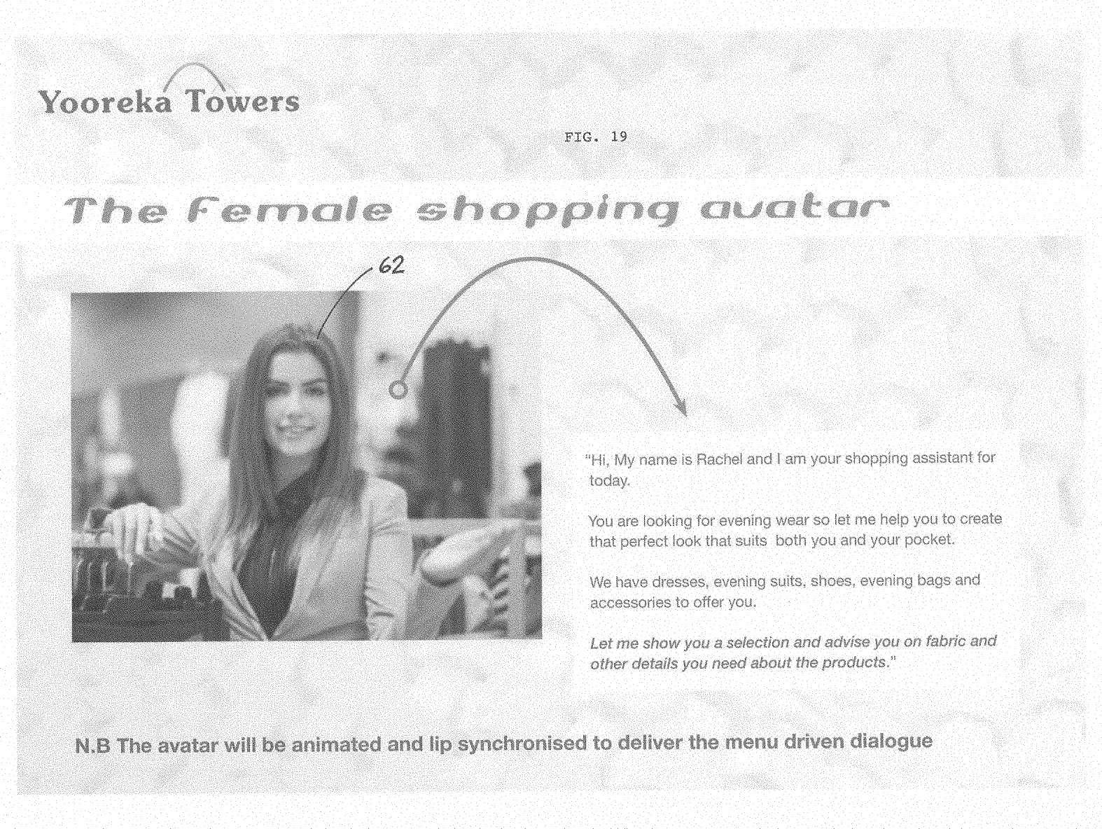

FIG. 18 illustrates a virtual store 59 with virtual garments (clothing) 60 and virtual handbags (purses) 61.

FIG. 19 illustrates a typical shopping avatar such as a male or female shopping avatar 62 providing a virtual salesperson who is visually explaining and audibly speaking through the speaker of the central processing unit (CPU) to a customer comprising the user (operator) of the CPU.

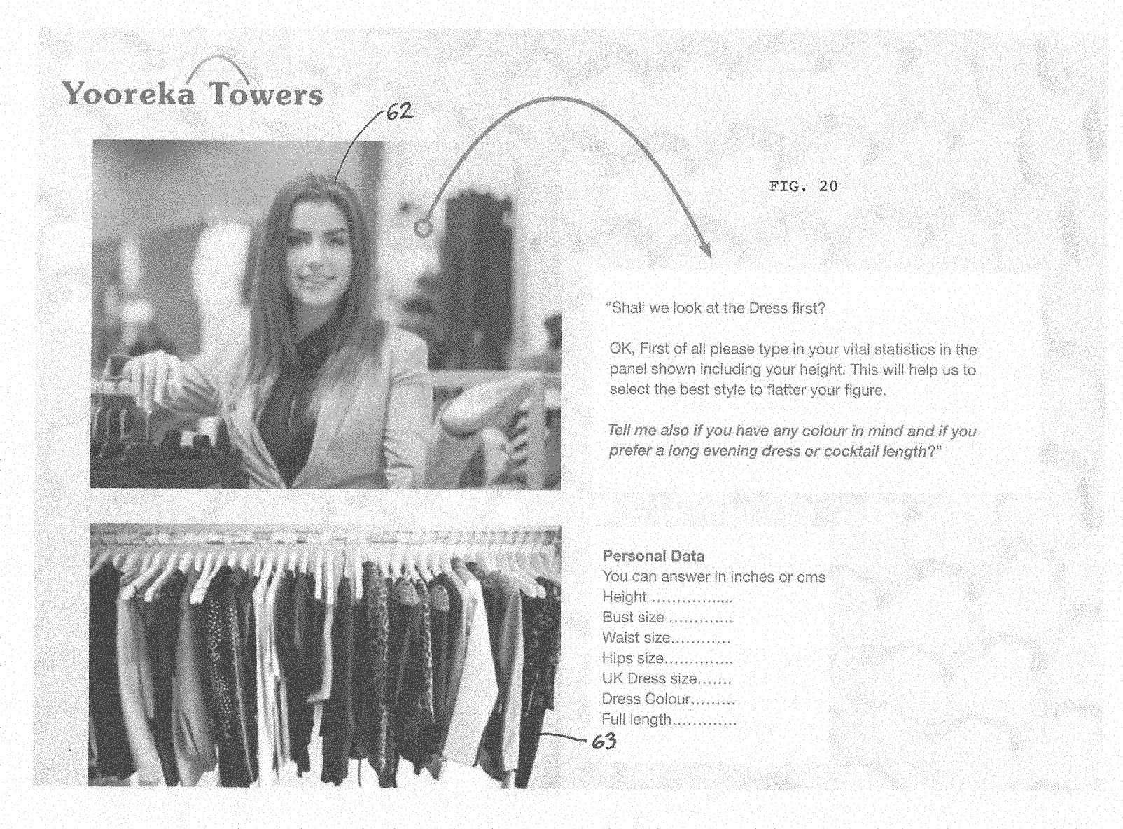

FIG. 20 illustrates the female shopping avatar 62 who is visually and audibly speaking about a rack of virtual dresses 63 to a customer comprising the user of the CPU and is requesting information about color of the preferred dresses and the measurements of the customer. The customer can electronically reply with a manual inputting device, such as a keyboard or electronic mouse, or audibly reply with the audible transmitter or microphone of the CPU.

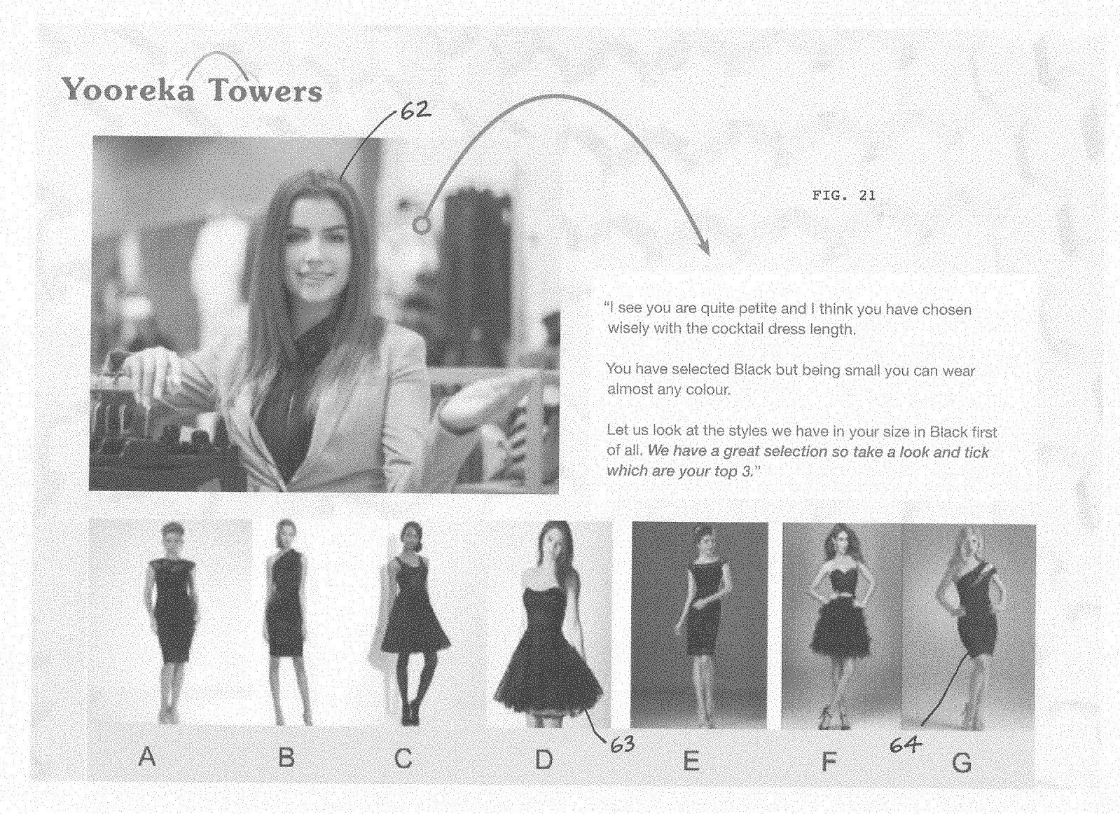

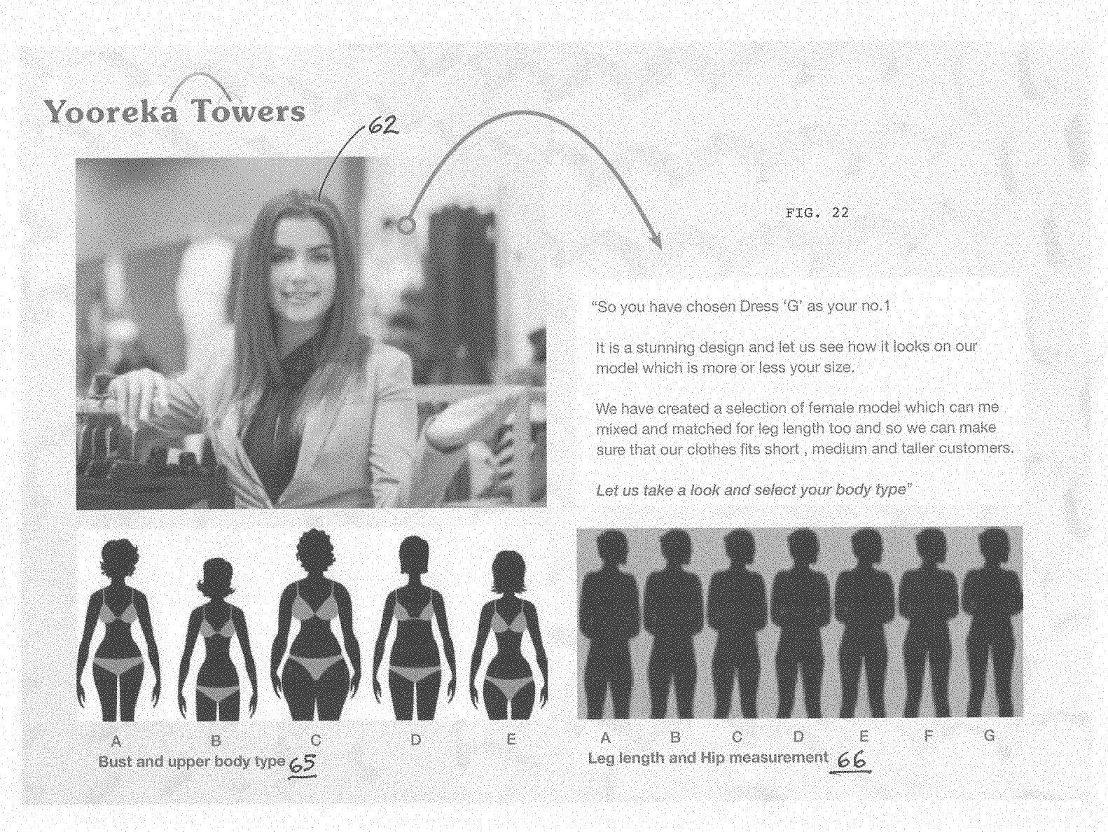

FIG. 21 illustrates the female shopping avatar 62 with different virtual dresses 64 and is visually explaining and audibly speaking about the different virtual dresses to the customer.

FIG. 22 illustrates the female shopping avatar 62 displaying different bust and upper body types 65 and different length and hip measurements 66 for the customer to select. The customer can again electronically reply with a manual inputting device, such as a keyboard or electronic mouse, or audibly reply with the audible transmitter or microphone of the CPU.

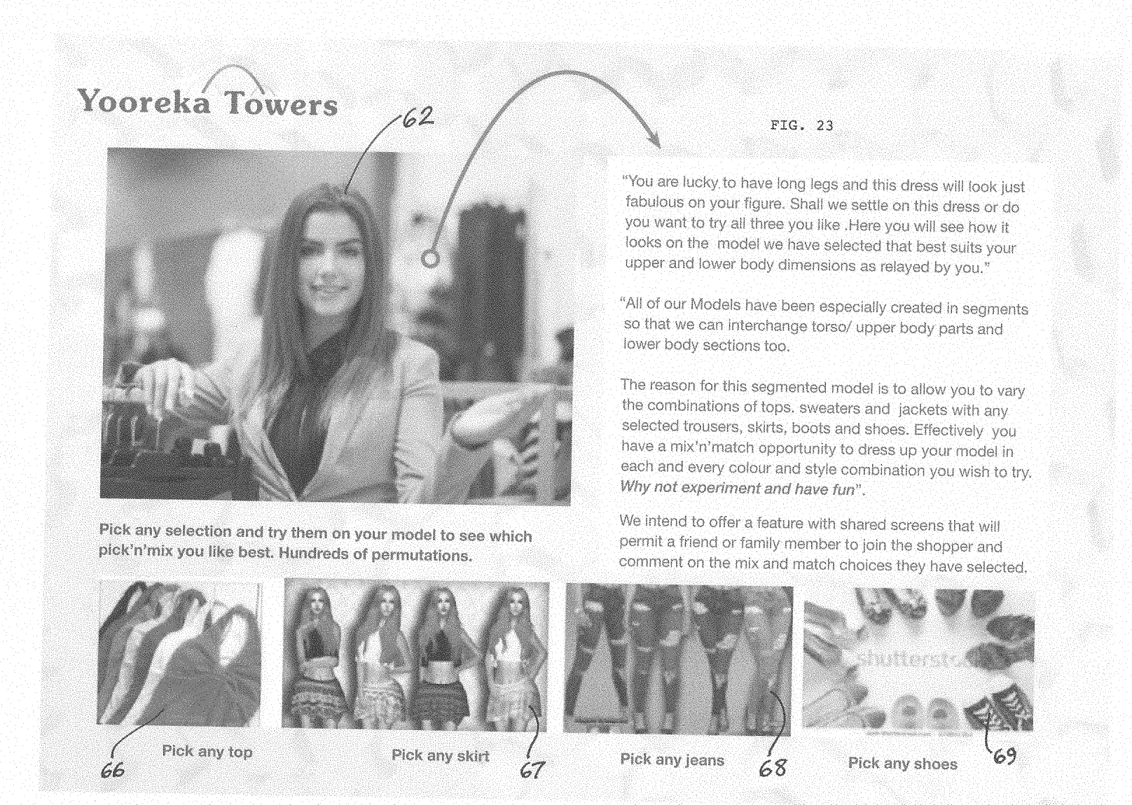

FIG. 23 illustrates the female shopping avatar 62 with different virtual garments (clothing) such tops 66, jackets, sweaters, skirts 67, jeans (pants) 68 and shoes 69 and is visually explaining and audibly speaking to the customer about mixing and matching various combinations of the clothing.

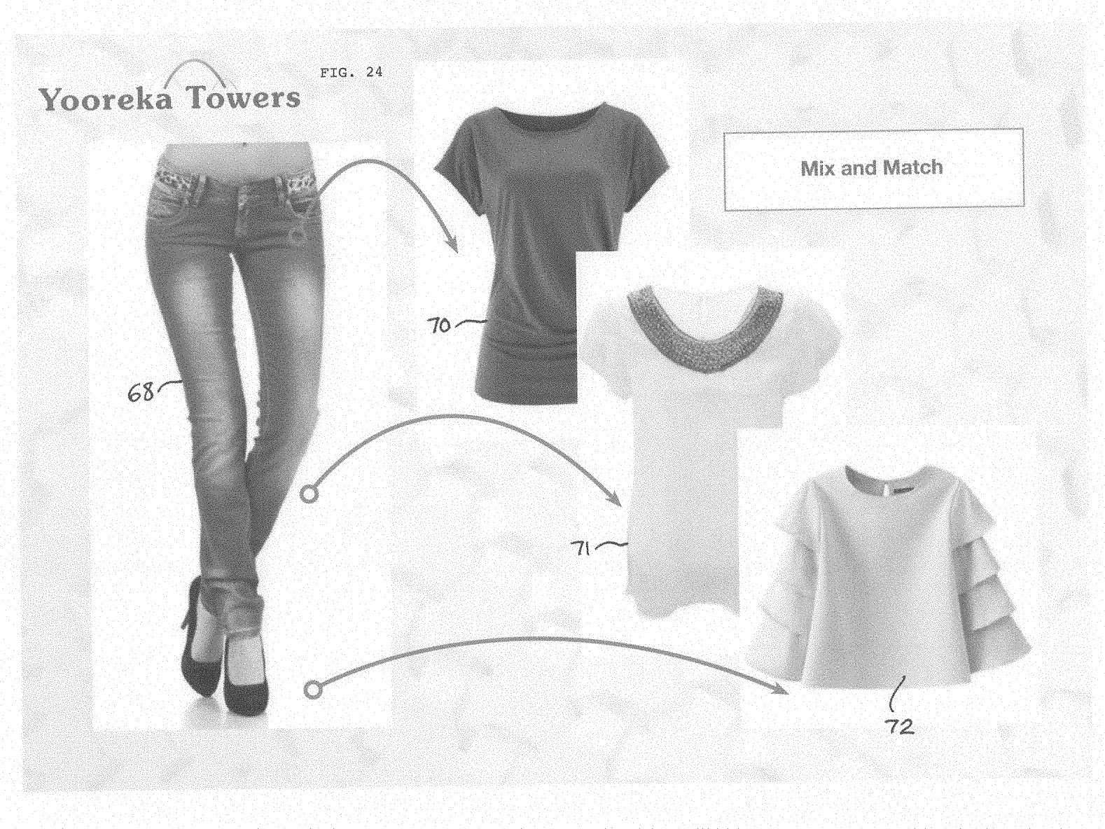

FIG. 24 illustrates a mix and match of virtual jeans 68 and tops (blouses) 70, 71 and 72.

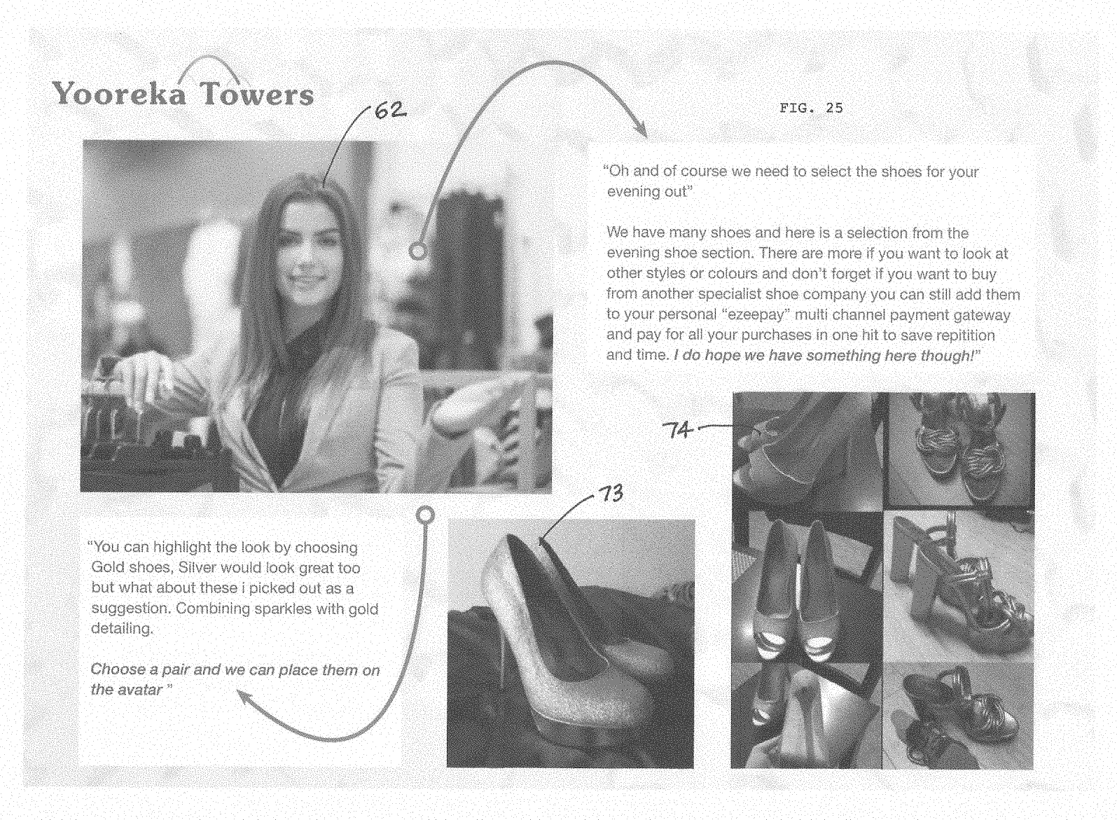

FIG. 25 illustrates the female shopping avatar 62 displaying different virtual shoes 73 and 74 and is visually explaining and audibly speaking about the different virtual shoes to the customer.

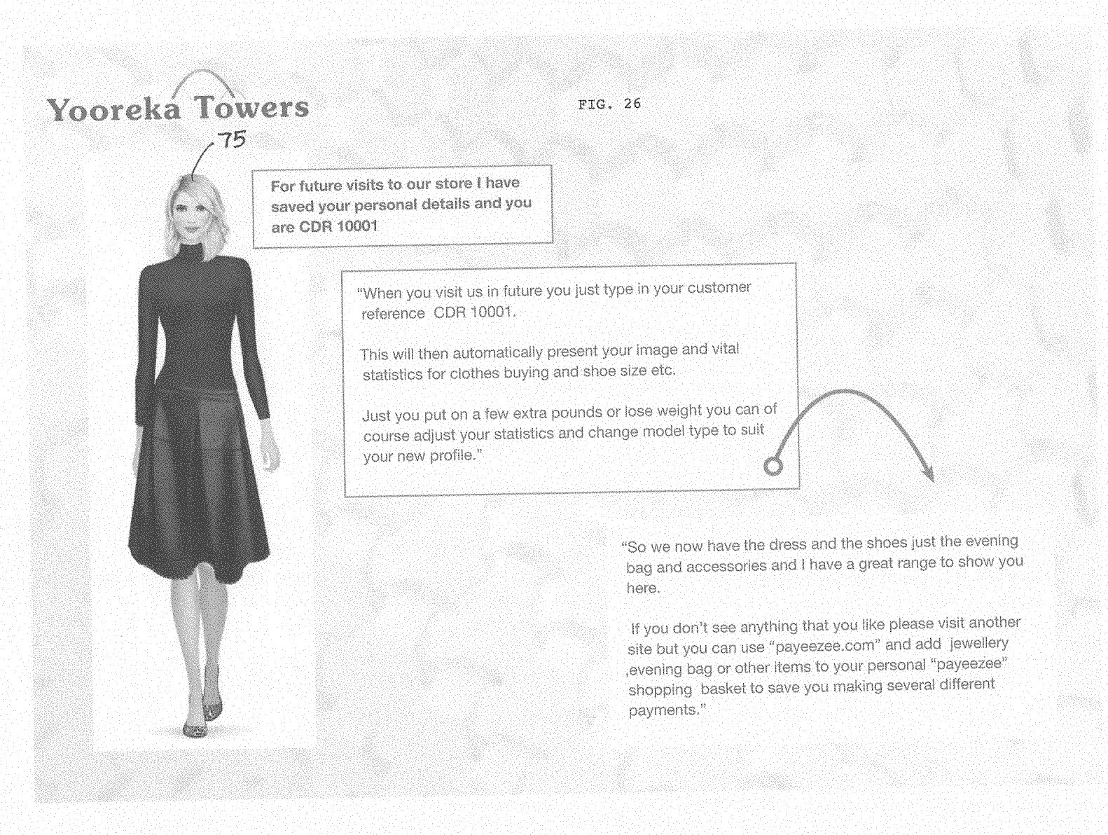

FIG. 26 illustrates another female shopping avatar 75 who is visually explaining and audibly speaking about saving customer information and that the customer can alter, modify or delete the information.

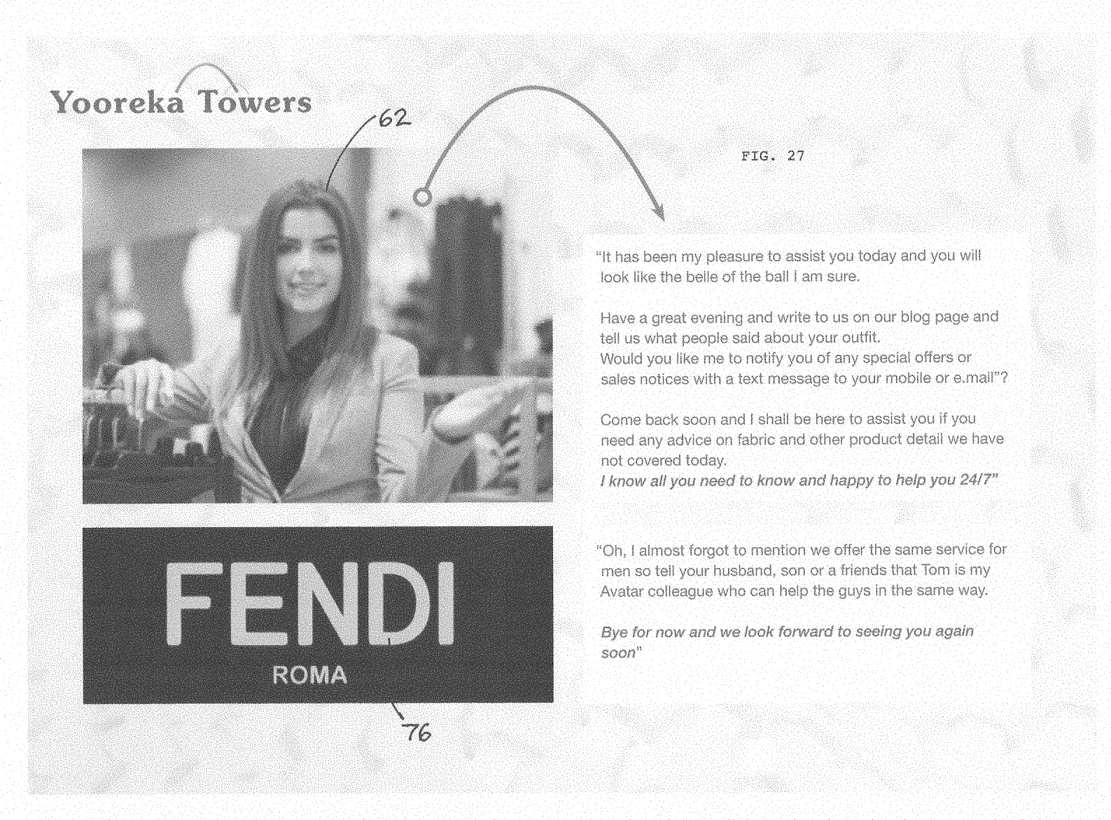

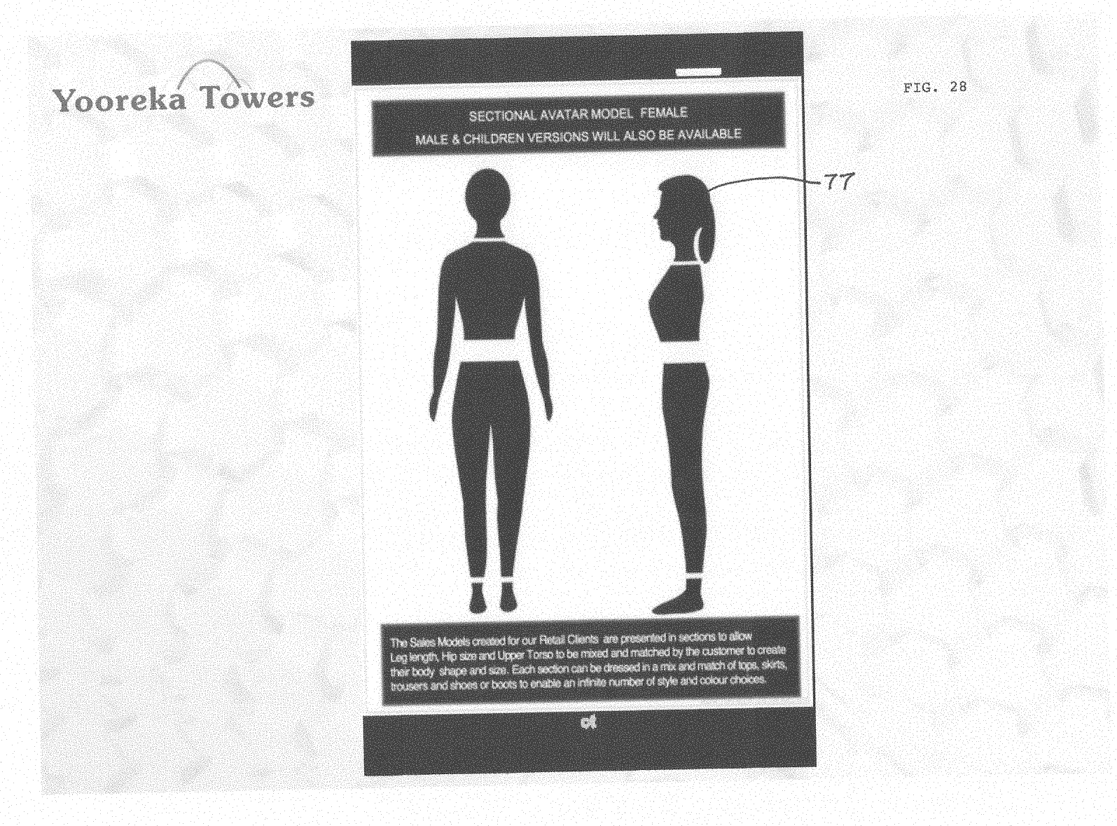

FIG. 27 illustrates the female shopping avatar 62 with a virtual brand 76 and explaining to the customer about other helpful matters and the use of a male shopping avatar.

FIG. 28 illustrates front and side views of a female avatar models 77.

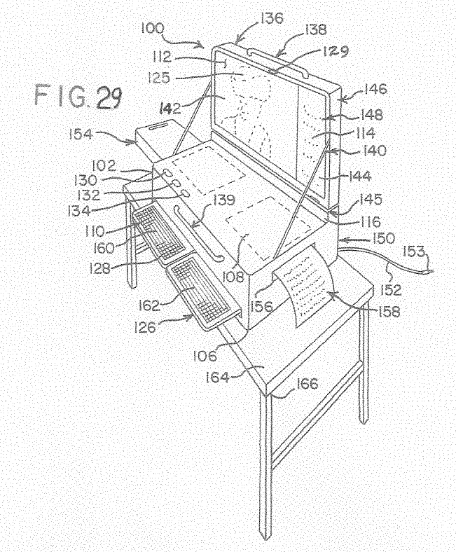

FIG. 29 illustrates an interactive electronic on-line retail communications system and process 100 for use in an on-line retail shopping station 102 or other places. The interactive electronic on-line retail communications system and process can comprise providing a computer system 106 with a printer 108, at least one inputting device 110, and one or dual (two) displays 112 and 114 which are operatively connected by hard wiring or wireless to a central processing unit (CPU) 116 for interaction between a virtual store and a customer. The customer can be: a man, woman, child, and/or client or patient.

The CPU can be: a computer, laptop computer, desktop computer, portable computer, microprocessor, tablet computer, wireless computer, wired computer, netbook, internet communications device, portable networking device, electronic communications device, network communications device, cloud network communications device, electronic subscriber device, mobile phone, flip phone, camera phone, clamshell device, radio telephone, cellular phone, smart phone, tablet phone, portable media player (PMP), personal digital assistant (PDA), wireless e-mail device, handheld electronic device, mobile electronic device, virtual reality device, virtual reality headset, and/or combinations of any of the preceding.

The computer system can include: one or more inputting device 126 and 128 (FIG. 29) and a camera 129. One of the inputting device can include optical scanner to scan a photograph of the customer so that the CPU with photographic software can generate an avatar that is similar in shape and appearance to the customer. The camera can be used with facial recognition software to help generate an avatar with the likeness and similar appearance of the customer. The computer system can further include at least one speaker 130 and an audible transmitter 132 or microphone 134. The speaker can be an external speaker, internal speaker, headphone jack, headphones, earplug jack and/or earplugs.

The on-line retail shopping station can comprise a mobile on-line retail shopping station 136 with a mobile case 136 (FIG. 29) having carry handles 138 and 139, collapsible struts 140, a hinged back lid 145 which accommodates one or more computer screens 142 and 144 providing displays. The hinged back lid 145 can be closed to a closed hinged position. The mobile on-line retail shopping station can have an internet connection 146 with LAN and/or WiFi. The right screen 144 can display a multi-lingual dialogue box 148. The mobile translation station can further have battery storage 148 under the built-in printer 108. The mobile translation station can further have a power cable socket 152 and a power cord 153. The mobile translation station can also have a retractable paper cartridge 154 on the left side to feed paper to the printer and has a printer outlet 156 on the right side to discharge the printed paper documents 158. The left screen 142 can display one or more avatars 125. The inputting devices can comprise dual retraceable key pads 160 or multi-lingual touch screens 162. The mobile case can be supported by a support surface 164 of a desk 166.

The interactive electronic on-line retail communications system and process can also comprise visually displaying and viewing indicia on at least one display operatively associated with the CPU. The dual displays can comprise side-by-side laterally spaced displays with each display comprising a screen, touch screen, touchpad, monitor and combinations of any of the preceding. The indicia can include: one or more avatars, text, words, numbers, alpha numeric images, characters, symbols, logos, designs, animation, black indicia, colored indicia, information images, videos, graphics, flags, globes, country names, country codes, country, pictures, maps, characters, cartoons, moving graphics, video clips, photographs, interactive games, electronic games, patient data information, data files, patient files, colors, vehicle colors, medications, and/or combinations of any of the preceding.

The interactive electronic on-line retail communications system and process can also include: electronically inputting information into the CPU through at least one inputting device operatively associated and electronically connected by hard wires or by wireless connection with the CPU. Each inputting device can be one or more of the following: a keypad, retractable keypad, screen pad, touch pad, keyboard, retractable keyboard, keys, buttons, electronic mouse, audible input, Bluetooth, verbal input device, microphone, transmitter, electronic mouse, optical scanner, card reader, optical scanner, streaming device, audio tape, video tape, computer disc (CD), digital video disc (DVD), universal serial bus (USB) device, or flash drive.

Advantageously, the interactive electronic on-line retail communications system and process can include providing an electronic audit trail of the electronic translations and audible communications. The electronic audit trail can comprise one or more of the following: electronically storing said electronic on-line retail shopping and audible communications in the CPU; downloading the electronic retail shopping and audible communications from the CPU into a flash drive, computer disc, backup tape, server or another CPU; printing a receipt of the shopping transaction; printing an encrypted version of the electronic translations and audible communications; downloading an encrypted version of the electronic on-line retail shopping and audible communications; electronically establishing a log of the electronic translations and audible communications; signing a printed version of the translations and audible communications; and witnessing a printed version or printed document(s) of the translation and communications.

The computer system preferably can have or access software comprising a computer program that can translate communications into many languages and can be linked via an avatar displayed on a computer screen and linked to a printer. The computer system can record a conversation in writing or orally. The computer system can also produce a printed, visual and/or audio audit trail document, which memorializes the dialogue between the virtual salesperson and customer.

Avatars speaking in menu driven communication in several languages can assist people in shopping and or using other services such as virtual offices where basic account and product information can be stored and offered to clients or would be clients.

These professional offices can be stand-alone virtual creations or placed in a virtual mall or street or both.

The same helpful avatars will be programmed according to the request and menus offered for information about products and or services.

When the overall concept is provided as a virtual film then the avatars will be in two classes. One will be a type that has no voice over internet protocol (VOIP) and does not interact with the site visitor and is programmed purely to populate the environment as shoppers, people chatting and pushing push chairs, carrying shopping bags with brand names as part of a special promotion by a brand paying for the exposure.

These silent avatars will just be designed to create ambience and population.

The second class of avatars can be leading ladies and leading men in this virtual creative world will be the avatars which are programmed and designed to deliver information and messages in several languages and programmed to interact with site visitors' requests.

These avatars will be used in sales of anything and everything from a hair pin to a private jet and also as office staff in a bank, insurance office and any other office based business or public service.

The on-line retail concept is not limited to selling clothes. The art of sales support and avatars can be programmed in menu driven conversations which will welcome customer and make them feel that they are not alone. The active avatars will advise and try to engender a sale as in the traditional bricks and mortar shops.

A virtual shop created in any style they wish to portray will have a one off payment to our architect design oriented team who can create an environment in any style and apparent size according to client needs.

Thereafter they will pay an annual rental fee and any changes or refresh can be conducted in hours and not weeks as with real shops.

As there can be no real staff, once avatars are produced and paid for the shop owner has no weekly salaries to pay and no conflicts to deal with. A virtual team of staff will be no problem in this aspect of human resources (HR) daily activities.

Prices can be fixed and we may not charge our customers for the shop fitting and may choose to take a small percentage of every item sold.

Benefits to the subscriber is the ability to see an avatar of themselves which is photo realistic and not a generic avatar with which they cannot identify.

The retail social network can allow people to share looks and experiences plus advice on brands, size differentials and quality etc.

Virtual real estate can be sold and each shop front can be individual and carry logos and signage of the client. The shop front can be a stand-alone web site or be tucked into our virtual high street or mall.

The use of games being introduced into the website will bring in a new dimension to the shopping experience and may induce children to share time with their parents in selected game nights where prizes will be offered.

The virtual malls and streets can be populated with non-interactive avatars to create ambience and reality.

Music or other promotions announcements can be made when special offers are promoted.

E-commerce can occur as a virtual a very real experience where customers can access avatars who will be programmed to respond in any language which the shopkeeper has asked us to create,

This on-line service can also extend to professional offices and a myriad of end users including banking, legal, Insurance, charities and therefore the avatars will be much more than just an avatar dressed up in a variety of clothing options.

This on-line retail concept of the invention can combine real estate with shopping via a virtual replica of both entities. The on-line retail concept can portray a virtual multi-story mall or maybe a single level virtual high street from a virtual environment design point of view.

The on-line retail concept can include a totally realistic tower block which will have a wonderful reception foyer with escalators and lifts or elevators which will be operating and have background avatars programmed to be using them and with an ambient sound in the background which captures the atmosphere of people in a public space. The animated characters in the background stage set can be changed periodically so as to refresh the virtual population. We shall see people carrying boxes or designer carrier bags which may bear famous names and provide us with product placement advertising revenue.

The virtual foyer will have kiosks selling drinks and confectionery such as coca cola and other brands portrayed as virtual replicas and our avatars using them. Advertising revenues will come from Coca Cola and others renting this virtual franchise space.

The on-line retail invention can have a concierge avatar to welcome site visitors to the virtual mall or virtual store and to guide visitors to the various virtual shops and floors within the virtual building. We anticipate that wherever these active avatars are placed that they will speak at least two languages.

There will be a virtual food hall and restaurants, Starbucks, Cafe Nero all created for our clients as virtual representations with avatar customers being serve by avatar waiters and waitresses and so advertising in a three dimensional (3D) environment.

We intend to place some tables which can be occupied by our subscriber/shopper who will be shopping using their own avatar created by our design team. Subscriber's avatars will be made from photographs supplied to us and they will replicate the shopper facially and in their actual physical shape and size taken from the vital statistics supplied to us.

This service can become part of their annual subscription charge and at an extra cost their image can be updated as they wish to accommodate changes in Hair color or length and weight gain or loss etc. The cost of an avatar creation may be borne by the licensee as part of a loyalty contract for shopping with them.

The on-line retail concept can also be portrayed as a high street with a variety of shops sharing a common shopping precinct area and wherein individual clients can portray their products and brand in their own virtual shop in a way that would be too costly to contemplate in a real town or city. Small businesses can attract global or national footfall which would be impossible in a high street which only usually attract the catchment local shoppers.

Once a shopper/subscriber has their personal avatar created it can be used and controlled to walk around the virtual store and floors. This will effectively become their alter ego and used to try on clothes shoes and other items of clothing.

The avatars of family and friends can also be created and via a 3D platform they can virtually meet to share the shopping experience at level 2 subscription. They will be able to buy garments for each other and to comment on choices made by others and advise as to whether they think the clothes or shoes suit them or not if asked for an opinion.

The site will have its own social media platform which can be something like Facebook but dedicated to shopping and interaction with the store-holders and shoppers in addition to the shoppers themselves communicating with each other.

The main thrust of the virtual real estate project is the creation of virtual real estate and a service to offer on-line shops of any size and specification as is true of real life when retailers choose location and brand image according to their budget.

The virtual real estate building will have a foyer as stated and some shops will be created here also along with temporary prime location kiosks for rental to charities or special promotions such as a car and mobile phone sales presentation as good examples. Anyone renting these spaces usually only rent for one or two weeks in real stores. These can be small but priced accordingly due to the human traffic that will virtually see them as they enter the site. I would like us to offer free space for a variety of charities where shoppers can make a contribution should they wish to.

Other floors can be offering a mix of shop fronts and store sizes offering products from various categories as the site visitor walks around the virtual site. Commercial subscribers will be the retailers themselves of course and we shall be offering a contract to lease a virtual retail space per annum and this will be set at a price per square meter at a fraction of the real cost of such a retail space as in effect we are creating virtual space and environments that do not have physical dimensions.

There can be a rental price based on location within the building and virtual space selected. There can also be a cost for a virtual shop front design and signage.

A menu of cost for interior fit out and design of the interior will be available.

A cost for any avatars which are not interactive types and just place or fold clothes and or pretending to be shopping or trying on clothes. Avatar type (A) being non interactive and just an extra in the film set as it were to populate the site to make it feel more real and ambient.

A higher cost will apply to Type (B) interactive avatars which will be designed to respond to requests for information about any product or sizing/stock etc. This information will be automatically updated by our team when changes are notified by the Tenant/Client

Interactive Avatars (B) can be programmed to respond to and to deliver specific information to the shopper and this data can be changed quite easily by our client or by our team as preferred. The data held in the avatar memory will be transient and subject to change as product ranges change or prices and colors may vary periodically.

Inventories of products will be forwarded as photographs showing front and rear views of any item to be presented in a virtual way which can be converted into virtual copies to show within the store.

Clothing will be created virtually and will move slightly in a realistic way when touched or selected to try on in our virtual changing room

Some products may be treated as augmented software in which case the product can be selected and transferred to another location or examined more closely as in electronic goods on sale such as a washing machine or dishwasher etc.

A social media platform and chatroom and forum can be available where family and friends can chat and discuss items before, during or after purchase,

If a family member or friend is also a member then it will be easy to buy for them too as anyone with their code of entry will be able to try clothes and outfits on them to see if they suit them and if they fit as our sizing will be calibrated for USA, UK and EU plus other international scales used.

We shall also advise on manufacturers sizing structures so as to assist shoppers to know that a size 10 in this make may be a size 12 in another manufacturer's ranges. This is a major problem for shoppers as sizes vary from brand to brand and we intend to establish a method of calibrating size variations which will depend on who our tenants are and each one will pay a charge for this service to be available should they want to add it.

The virtual changing room will also be realistic and allow shoppers to see themselves in 360 degree views to enable a full evaluation of how they look from all angles.

The on-line retail concept can also include a gaming element where for example our subscribers and clients can announce a gaming night where shoppers are invited to search for 20 clues hidden in various items or departments as the case may be. These can be inside a virtual coat pocket or a shoe, under a book or lap top and the prizes may be a free wardrobe or a holiday etc. This game will ensure and promote that site visitors look at everything and are exposed to all products and so may be attracted to another sale they would not have made. It is a way of bringing the globally popular gaming concept into shopping and a way of engaging people and families to go on the treasure hunt. Other games will be added and one of our Malaga team is specialized in gaming and will add to my own ideas.

Sales will be linked to stores if they require it which is likely. In this way we shall update their stock management and this service will be charged out as an extra.

We shall offer payment gateways and these can be PayPal, Debit or Credit Card and any other transaction system we incorporate. We can also have a Loyalty card system in place.

Our tenants can pay us a percentage on each sale made in addition to the monthly shop rental and add-ons they choose.

The virtual superstore will have various floors selling anything and everything anyone could want to buy and we aim to have a clearance floor which will portray clearance items in a much better and inviting way using room settings for furniture and avatar models positioned on a catwalk showing off clothing.

We also intend to structure a deal with music companies to have their latest albums playing as people enter the store. We shall arrange a payment per minute or hourly rate and linked to albums sold in our store or via any other link.

Among the many advantages of virtual retail, virtual real estate and services to subscribers and customers of on-line retail of the invention include:
1. Rent will be a fraction of the real cost
2. There will be no local rates to pay
3. No lighting or heating bills
4. No security costs
5. No insurance costs for building and stock
6. No staff costs
7. No maintenance costs other than upgrades they ask for
8. No parking issues
9. No theft
10. National or global exposure and footfall and not just local traffic.
11. Lower overall costs
12. Easy stock taking
13. Multi lingual avatar presence
14. 24/7 operation
15. Global presence
16. May choose International Malls to be created i.e: London, Paris, New York, Dubai etc.
17. Economical.
18. Attractive.
19. Efficient.
20. Effective.

This on-line retail concept is not just about selling clothes but for selling homewares, furniture, do-it-yourself (DIY) products, outdoor and garden equipment, books, music, phones, computers, televisions, electrical equipment, and white goods. Anything that needs salesmanship.

There are many sales advantages for our clients using sophisticated website selling as opposed to the huge costs associated with bricks and mortar high street stores.

The trend towards shopping on-line has been growing year on year. The market size is now calculated in trillions of pounds. ‘Bricks & Mortar’ is losing out to ‘Clicks & Mortar’

What has been lost in this major social shopping change? What do people miss when buying online? Salesmanship. No one sells us anything on line. We are left to choose whether we and buy or not. This results in many missed sales opportunities globally. This invention and Yooreka Towers solves the problem.

In the process of this invention, avatar sales support is provided. In the process, each virtual store can have a team of avatars to welcome customers, speak to customers and invite customers into the virtual store to buy. Male and female programmed avatars can have lip synchronized speech capability relating to the products or services to be purchase. Preloaded menus will activate the avatar interaction.

For example, the avatar sales person can say “Welcome to virtual store” “How can I help you?” You are looking to buy clothes I see. “Ah Evening Wear” (so you want to look fabulous). “We have many options in dresses, tops, shoes, evening bags and accessories. Let us take a look”.

The inventive process for Yooreka Towers can also include an on-line real time shopping game and/or treasure hunt. For example, we can virtually hide 10 items in the women's clothing section, 10 items in the men's section, 10 items in the children's section, and 10 items in the junior clothes section. Hidden in certain items can be a voucher offer a cash discount on selected items in each department. These vouchers can also apply to furniture, do it yourself (DYI) items and other products sold on-line. Once vouchers have been collected by the shopper (customer), the shopper can use them or save them in their loyalty account such as at an easy payment station or save the vouchers to pay towards a more expensive item. It is preferred that the vouchers be used for the purchases rather than a cash reward.

Significantly, the avatar based retail concept of this inventive process is designed to bring salesmanship from Brick and Mortar to the world of Clicks and Mortar. More features can be added to the process. An easy pay station, sometimes referred to as “eezeepay” can be used in the process to provide a multi-channel payment gateway.

The on-line process of this invention can include the addition of a personal shopping basket wherein shoppers using the shopping mall system have the facility of shopping in a variety of stores and selecting a dress from one, a coat from another, shoes from a shoe retailer, accessories from a specialist shop and so on. If furnishing a house the shopper can choose sofas from shop A, chairs from shop B carpets from store C and curtains & soft furnishings from shop D. White goods and IT purchases from a separate specialist store offering the best deal.

The process may link each and every sale from an infinite variety of on-line suppliers into my own personal shopping basket and then pay for all items through one payment gateway. The payment gateway may be a global or regional continent service to speed up transactions. The software of the process can be global and hyper-scale transactions managed via a cloud based operation that can react to add ons and bolt on features quickly and easily without disruption to anyone's main website.

Monolithic architecture is outdated and cannot cope with high demand and the future will surely be focused on multi-functional microsite compilations which can adapt and adopt quickly. The personal shopping basket wherein a shopper can select items from a variety of different sites and yet pay through one payment gateway instead of having to follow the payment procedure with each purchase separately. The facility of buying anything and everything through one payment gateway from a selection of disparate suppliers seems to be previously unavailable.

In the fashion sector a female may wish to create a complete look by purchasing each item of the outfit from different suppliers. We can provide their facsimile avatar that can be recognized as themselves and clothe it as per the selections they make and in this way they can mix and match items from different suppliers and yet pay through one gateway.

The improved on-line retail process of this invention is effective, inexpensive, and fate and is especially useful for shopper (customer) and global retailers.

The improved on-line retail process of this invention can have a selection of avatar salespeople that can be programmed in any language.

Advantageously, the improved online system and process of this invention has many advantages, including but are not limited to:

1. To introduce Avatar based interactive salesmanship to the internet, i.e. commerce and retail in general.

2. To make multi purchases easier by the inclusion of a retail payment gateway that will enable shoppers to visit several different sites and to select a mixed variety of purchases into their own shopping basket and yet pay for them all via one payment gateway.

3. To offer site visitors to our site or our clients sites an opportunity to create a sectional mannequin from a menu of body parts which will be designed to provide standard and non-standard dimensions of the human form. These flesh coloured body sections can be in ethnic skin tones to suit all races.

4. There will be a section for arms and upper torso; lower torso and hips, legs of varying shape and length, Feet, Hands, Shoulders, neck and head.

5. The shopper selects one from each section which will include a front, side and rear view and so allowing them to make up their own blank personal profile mannequin which they can then dress in any product of clothing, footwear or headgear and even accessories to achieve a complete look and outfit.

6. The personal profile mannequin can be rented for a nominal fee and is theirs to use when shopping anywhere to see how they look in any suppliers clothes and to enable them to mix and match as many options as they like from different sites.

7. We may charge each retailer a % of each sale made using our tailored customer mannequins or use other means to monetise the universal mannequin and or the multi-channel payment gateway.

8. The mannequin can be refreshed and altered as and when the shopper changes weight or their figure outline changes and so the mannequin grows and changes with them. Children and teenagers start out with younger mannequin profiles and gradually change their outline and dimensions as they grow. They can retain each selection as they grow older and compare their look over the years of development.

9. A typical shopper whether male or female will create their own mannequin (dress up doll) according to their inputs on leg length and shape of legs. The same will be done with arms and hands, feet and head shape. In this way the shopper has a personal representation of their body shapes and sizes for each section and so can see themselves in a wide selection of separate items purchased from one on-line retailer or from a combination of items across several sites.

10. We will offer an additional feature wherein they can submit a photograph of their face in front view, side profile and rear view and they can copy and paste these onto their own mannequin head and crop the photos to fit or at a small cost ask one of our aftersales team to do this for them. The customer can of course try out any number of photographs until they select the one they like the best and so place on to the head of their mannequin. This can be changed as and when their hairstyle or colour changes.

The responsibility of choice of facial image will remain with them and they use this facility or not as they prefer. Otherwise we shall offer a menu of several shapes and styles with random faces created by our graphics team.

11. When shopping the customer can copy and paste a dress, pair of trousers, tops, sweaters, a suit, a coat or any item of clothing and see a front and rear view of the item from the site. These will initially be based around a front and rear view that will be static. We may animate these mannequins if cost and other considerations make this commercially viable.

12. Our business customers will also be the retailers themselves who will be offered a contract wherein their clothing and footwear catalogue can be amended by our graphics team or their own so as to enable the products selected to be placed on each and every mannequin. They will supply a front and rear view of each item and these will be created way in advance of each season by at least 6 months to allow the catalogue to be organized in order of sizes and availability in each size. The size matrix will cater for UK, EU, US and other regional standards known to the shoppers.

13. The shopper selects the item according to the size matrix appropriate for their body shape and size and offer the item to the mannequin to see how it looks in isolation or in addition to another item from the same or different supplier.

14. We shall introduce an advice avatar who will only be a head and shoulders creation of both male and female sales assistants.

15. These avatars can be pre-loaded with information about each product in the catalogue at the time of compilation and contain advice on sizing and guides as to whether the make is generous or not and so assist in helping the shopper to select the correct size for trial.

16. We will offer a simple colour coded outline when offered to the mannequin that will show up as red if not a good fit and green if it should be fine. This advice will be provided by the retailer who should know which makes are not consistent with the general accepted sizing for the region.

17. The sales avatars can be 3D models and be totally fictional characters with lip synchronised speech that can be programmed to be accurate or a generic movement of the mouth. Alternatively we can supply actual sales people in gif format who can assist the sale. We can also offer a Live-chat link so that the customer can ask for specific advice and receive it as a live link.

18. We shall make the live chat links open networks if selected to enable two individual shoppers to share a screen and to see the mannequin being dressed and so discuss which items best suit the shopper. This will become a network forum to be used by shoppers and to share experiences and selection advice and combination choices that looked great.

19. The sales avatars can be programmed to offer advice on each item in the retailer's catalogue in relation to materials and other specific advice on items which may not be clothing but could be items of furniture or DIY products for example. The on-line process and system of the invention is designed to be of use in the sale of any items on-line in addition to clothing and footwear. Jewelry can be tried on to see how it suits their head and shoulders or ears etc. and watches, bracelets to see how they look on the wrists.

20. The sales avatars will welcome site visitors with a warm greeting in various languages, Hello, Buenos Dias, etc. and then offer advice in the language selected. They can be programmed to offer advice and also linked to a CMS can identify customer preferences and record them for future sales. The Avatar will also link to CRM systems to ensure that stock control and availability are constantly updated to the main retailer site as and when each sale is made.

21. Should our retail customer elect to use Live-Chat sales assistants then this interaction may include some encouraging sales chat, such as: “That dress looks amazing on you”. “The shoes you have selected match it perfectly too”. “You will look great at the party or the wedding dress and veil are a stunning choice for you, would you like to see the selection of shoes we recommend or are you buying from another site and want to try them on with this dress?”

22. The Sales avatars will be there 24/7 and always pleasant, non-intrusive or may be turned off if not needed. The virtual sales staff can be programmed to introduce special offers, sales items and can be programmed to represent furniture, soft furnishings, do it yourself (DIY) products, food and any item which can be purchased on-line.

23. Food avatars can advise on dietary information, e. colours and a host of other information including recipes etc.

24. The payment gateway will be designed to enable the shopper to select any number of items from either one site or several and to place them all in their personal shopping basket and yet pay for them all with one single payment to save time and effort.

25. The on-line process may link the purchases and apportion the appropriate payment to each supplier as coded and referenced.

26. The hidden treasure game. This feature will be available and wherein a retailer may announce a treasure hunt being available on a certain day and in which shoppers may be invited to seek out hidden items or codes placed in a shoe or the pocket of a jacket, behind a cushion or curtain or in a packet of biscuits etc. depending on the site. For example, the first 50 shoppers to solve all the puzzle and submit the correct answers will be awarded a prize which may be a 25% discount or a free item etc. as their reward. This may encourage family shopping and engage the whole family which would be a social benefit. Other games will be created and offered to our retail clients and in turn will be offered to their shoppers.

The business model for this process and its investors can be based on licensing revenues from the global retailers using the retail internet system which will be an annual or monthly fee. In addition Yooreka can charge a one off up front design fee to integrate the retailers' products into the system. We may elect to take a percentage of each sale made around the world from each retailer and could therefore provide some of the design services FOC as an incentive to join.

The interactive electronic on-line communications system and process of this invention can also be useful for use in an on-line wholesale shopping and business to business purchases.

Although embodiments of the on-line process, system, and retail concept of invention have been shown and described, it is to be understood that various modifications, substitutions, and rearrangements of parts, components, and/or process (method) steps, as well as other uses, shapes, construction, and design of the on-line process, system and retail concept can be made by those skilled in the art without departing from the novel spirit and scope of this invention.

What is claimed is:

1. An interactive electronic on-line retail communications process for use in on-line retail shopping, comprising:
providing a computer system with at least one display and inputting device operatively connected by hard wire or wireless to a central processing unit (CPU) for interaction between a virtual store and a customer comprising the user of said CPU;
generating virtual products on the display by the CPU; and
generating at least one interactive avatar on the display to assist the customer in selecting at least one of the virtual products.

2. An interactive electronic on-line retail communications process in accordance with claim 1 wherein:
said CPU is selected from the group consisting of: a computer, laptop computer, desktop computer, portable computer, microprocessor, tablet computer, wireless computer, wired computer, netbook, internet communications device, portable networking device, electronic communications device, network communications device, cloud network communications device, electronic subscriber device, mobile phone, flip phone, camera phone, clamshell device, radio telephone, cellular phone, smart phone, tablet phone, portable media player (PMP), personal digital assistant (PDA), wireless e-mail device, handheld electronic device, mobile electronic device, virtual reality device, virtual reality headset, and combinations of any of the preceding; and
said display selected from the group consisting of a screen, touch screen, touchpad, monitor and combinations of any of the preceding.

3. An interactive electronic on-line retail communications process in accordance with claim 1 wherein:
said customer electronically transmitting information to the CPU with said inputting device;
said inputting device is selected from the group consisting of a keypad, retractable keypad, screen pad, touch pad, keyboard, retractable keyboard, keys, buttons, electronic mouse, audible input, Bluetooth, verbal input device, microphone, transmitter, electronic mouse, optical scanner, card reader, optical scanner, streaming device, audio tape, video tape, computer disc (CD), digital video disc (DVD), universal serial bus (USB) device, flash drive, and combinations of any of the preceding.

4. An interactive electronic on-line retail communications process in accordance with claim 3 wherein said information is audible information spoken by the customer into a microphone of the CPU.

5. An interactive electronic on-line retail communications process in accordance with claim 3 wherein:
said information is visual information comprising a photograph of the customer optically scanned into the optical scanner of CPU by the customer; and
said avatar comprises an avatar which is visually similar to the customer based upon the photograph of the customer.

6. An interactive electronic on-line retail communications process in accordance with claim 3 wherein:
said information is visual information comprising a photograph of the customer by a camera of CPU; and
said avatar comprises an avatar which has a virtual face similar to the face of the customer based upon the photograph of the customer.

7. An interactive electronic on-line retail communications process in accordance with claim 3 wherein:
said information comprises measurements of the customer;
said measurement selected from the group consisting of height, weight, sleeve length, pants length skirt size, skirt length, waist size, bust size, with collar size, race, skin color, eye color, hair color, hair style, hair length, and combinations of any of the preceding; and
said avatar comprises an avatar which has an appearance or likeness similar to the customer based upon the information provided by the customer.

8. An interactive electronic on-line retail communications process in accordance with claim 3 wherein said avatar is selected by the customer with said inputting device from the group consisting of a three dimensional (3D) avatar, animated avatar, avatar with lip synchronized speech, virtual mannequin, personal profile mannequin, an avatar from an electronic menu of different avatars, and combinations of any of the preceding.

9. An interactive electronic on-line retail communications process in accordance with claim 1 wherein said avatar is wearing, holding or pointing towards at least one of the virtual products.

10. An interactive electronic on-line retail communications process in accordance with claim 1 wherein:
said avatar comprises a virtual salesperson selected from the group consisting of an interactive shopping avatar, an advice avatar, an actual salesperson in a gif format, and combinations of any of the preceding;
said interactive shopping avatar comprising a female shopping avatar, male shopping avatar, or animated animal; and
said virtual salesperson electronically providing information about the virtual products to the customer.

11. An interactive electronic on-line retail communications process in accordance with claim 10 wherein said virtual salesperson electronically transmits visual information on the display to the customer about the virtual products.

12. An interactive electronic on-line retail communications process in accordance with claim 10 wherein said virtual salesperson electronically transmits audible information spoken through the speaker of the CPU to the customer about the virtual products.

13. An interactive electronic on-line retail communications process in accordance with claim 1 including:
generating at least one virtual facility with the virtual products on the display; and
said virtual retail facility selected from the group consisting of a virtual shopping mall, virtual shop, virtual store, virtual high street, virtual room setting, virtual catwalk virtual restaurant, virtual outdoor setting, virtual furniture store, virtual hardware store, virtual garment store, virtual clothing store, virtual shoe store, virtual office, virtual e-commerce bank, virtual financial institution, virtual currency exchange; and a virtual department store.

14. An interactive electronic on-line retail communications process in accordance with claim 1 wherein said virtual products are selected form the group consisting of virtual goods, virtual white goods, virtual wares, virtual garments, virtual clothes, virtual tops, virtual blouses, virtual jackets, virtual coats, virtual pants, virtual jeans, virtual skirts, virtual scarfs, virtual sweaters, virtual, shoes, virtual handbags, virtual purses, virtual cosmetics, virtual services, virtual real estate, virtual house, virtual apartments, virtual flats, virtual currency, virtual crypto coins, virtual bit coins, virtual loans, virtual mortgages, virtual banking, virtual insurance, virtual games, virtual vehicles, virtual cars, virtual automobiles, virtual trucks, virtual sports utility vehicles, virtual tools, virtual fasteners, virtual garden equipment, virtual supplies, virtual art, virtual jewelry, virtual collectibles, virtual memorabilia, virtual sports memorabilia, virtual food, virtual travel, virtual vacations, virtual holidays, virtual cruises, virtual tickets, virtual cruise tickets, virtual travel tickets, virtual tour tickets, virtual bus tickets, virtual railroad tickets, virtual airplane tickets, virtual theater tickets, virtual event tickets, virtual concert tickets, virtual sports tickets, virtual movie tickets, virtual movies, virtual prerecorded television programs, virtual software, virtual supplies, virtual devices, virtual equipment, virtual garden equipment, virtual furniture, and combinations of any of the preceding.

15. An interactive electronic on-line retail communications process in accordance with claim 1 including;
generating at least one inactive passive silent avatar on the display to enhance the ambience of virtual shopping;
generating music for the customer through the speaker of the CPU to enhance retail shopping,
generating a virtual shopping cart on the display; and
said interactive electronic on-line retail communications process comprises a social media platform and virtual chatroom.

16. An interactive electronic on-line retail communications process in accordance with claim 1 wherein
said customer electronically purchases in a transaction at least one product from the virtual products through a virtual retail payment gateway; and
generating an electronic audit trail with the CPU of the transactions and communications during virtual shopping including an electronic receipt and electronic visual copy and/or sound recording of the virtual shopping.

17. An interactive electronic on-line retail communications process in accordance with claim 16 wherein
said computer system includes a printer operatively connected by hard wire or wireless to said CPU; and
printing said audit trail on the printer.

18. An interactive electronic on-line retail communications process for use in on-line retail shopping, comprising:
providing a computer system with at least one display and inputting device operatively connected by hard wire or wireless to a central processing unit (CPU) for interaction between a virtual store and a customer comprising the user of said CPU;
generating virtual products on the display by the CPU;
generating at least one interactive avatar on the display to assist the customer in selecting at least one of the virtual products;
said CPU is selected from the group consisting of: a computer, laptop computer, desktop computer, portable computer, microprocessor, tablet computer, wireless computer, wired computer, netbook, internet communications device, portable networking device, electronic communications device, network communications device, cloud network communications device, electronic subscriber device, mobile phone, flip phone, camera phone, clamshell device, radio telephone, cellular phone, smart phone, tablet phone, portable media player (PMP), personal digital assistant (PDA), wireless e-mail device, handheld electronic device, mobile electronic device, virtual reality device, virtual reality headset, and/or combinations of any of the preceding;
said display selected from the group consisting of a screen, touch screen, touchpad, monitor and combinations of any of the preceding;
electronically transmitting information from the customer to the CPU by said inputting device;
said inputting device is selected from the group consisting of a keypad, retractable keypad, screen pad, touch pad, keyboard, retractable keyboard, keys, buttons, electronic mouse, audible input, Bluetooth, verbal input device, microphone, transmitter, electronic mouse, optical scanner, card reader, optical scanner, streaming device, audio tape, video tape, computer disc (CD), digital video disc (DVD), universal serial bus (USB) device, flash drive, and combinations of any of the preceding;
generating at least one virtual facility with the virtual products on the display;
said virtual retail facility selected from the group consisting of a virtual shopping mall, virtual shop, virtual store, virtual high street, virtual room setting, virtual catwalk virtual restaurant, virtual outdoor setting, virtual furniture shop, virtual hardware store, virtual garment store, virtual clothing store, virtual shoe sore, virtual office, virtual e-commerce bank, virtual financial institution, virtual currency exchange; and a virtual department store;
said virtual products are selected form the group consisting of virtual goods, virtual white goods, virtual wares, virtual garments, virtual clothes, virtual tops, virtual blouses, virtual jackets, virtual coats, virtual pants, virtual jeans, virtual skirts, virtual scarfs, virtual sweaters, virtual, shoes, virtual handbags, virtual purses, virtual cosmetics, virtual services, virtual real estate, virtual house, virtual apartments, virtual flats, virtual currency, virtual crypto coins, virtual bit coins, virtual loans, virtual mortgages, virtual banking, virtual insurance, virtual games, virtual vehicles, virtual cars, virtual automobiles, virtual trucks, virtual sports utility vehicles, virtual tools, virtual fasteners, virtual garden equipment, virtual supplies, virtual art, virtual jewelry, virtual collectibles, virtual memorabilia, virtual sports memorabilia, virtual food, virtual travel, virtual vacations, virtual holidays, virtual cruises, virtual tickets, virtual cruise tickets, virtual travel tickets, virtual tour tickets, virtual bus tickets, virtual railroad tickets, virtual airplane tickets, virtual theater tickets, virtual event tickets, virtual concert tickets, virtual sports tickets, virtual movie tickets, virtual movies, virtual prerecorded television programs, virtual software, virtual supplies, virtual devices, virtual equipment, virtual garden equipment, virtual furniture, or combinations of any of the preceding;
said avatar on said display wearing, holding or pointing to at least one of the virtual products;
said avatar comprises a virtual salesperson selected from the group consisting of an interactive shopping avatar, an advice avatar, an actual salesperson in a gif format, and any combinations of the preceding;
said interactive shopping avatar comprising a female shopping avatar and a male shopping avatar; and
said virtual salesperson electronically providing information about the virtual products to the customer including electronically transmitting visual information on the display to the customer about the virtual products and audible information spoken through the speaker of the CPU to the customer about the virtual products.

19. An interactive electronic on-line retail communications process in accordance with claim 18 wherein the information which is electronically transmitted to the CPU by the customer with said inputting device comprises information selected from the group consisting of:
visual information comprising a photograph of the customer optically scanned into the optical scanner of CPU by the customer; said avatar includes another avatar which is visually similar to the customer based upon the photograph of the customer;
visual information comprising a photograph of the customer by a camera of CPU; said avatar includes a further avatar which has a virtual face similar to the face of the customer based upon the photograph of the customer;
measurements of the customer selected from the group consisting of height, weight, sleeve length, pants length skirt size, skirt length, waist size, bust size, with collar size, race, skin color, eye color, hair color, hair style, hair length, and combinations of any of the preceding; said avatar includes one more avatar which has an appearance or likeness similar to the customer based upon the information provided by the customer; and
audible information spoken into a microphone of the CPU by the customer.

20. An interactive electronic on-line retail communications process in accordance with claim 18 wherein said avatar is selected from the group consisting of: a three dimensional (3D) avatar, animated avatar, avatar with lip synchronized speech, a virtual mannequin, a personal profile mannequin, an avatar from an electronic menu of different avatars, and combinations of any of the preceding.
